(19) United States
(12) Patent Application Publication
(10) Pub. No.: US 2013/0015227 A1
(43) Pub. Date: Jan. 17, 2013

(54) APPARATUS AND PROCESS FOR FORMING GRANOLA PIECES

(71) Applicant: Michael Feneley, Marshall, MI (US)

(72) Inventor: Michael Feneley, Marshall, MI (US)

(21) Appl. No.: 13/547,622

(22) Filed: Jul. 12, 2012

Related U.S. Application Data
(60) Provisional application No. 61/506,726, filed on Jul. 12, 2011.

(51) Int. Cl. A23P 1/10; A23L 1/164; B26F 3/00

(52) U.S. Cl. 225/2; 225/103; 225/96; 225/4

(57) ABSTRACT

A rotary sizing apparatus to form granola pieces includes a transfer device to move a granola slab and a diversion portion extending along a transfer axis between a receiving end and an exit end for receiving the slab from the transfer device. A rotary breaking device is disposed adjacent and in spaced relationship to the exit end for receiving the granola slab. The rotary breaking device is rotatable about a rotary breaking axis disposed above the transfer axis, and includes at least one blade for rotatably striking the top side of the moving granola slab to break the granola slab into a plurality of granola pieces. The at least one blade engages the top side of the granola slab during rotation of the blade to establish a breaking angle between zero and forty five degrees relative to the top side of the granola slab.

### CROSS-REFERENCE TO RELATED APPLICATIONS

This non-provisional patent application claims the benefit of U.S. Provisional Patent Application Ser. No. 61/506,726 filed Jul. 12, 2012, entitled “Apparatus and Process for Forming Granola Pieces”.

### BACKGROUND OF THE INVENTION

1. Field of the Invention

The invention relates generally to a rotary sizing apparatus for forming granola pieces and a method of using the same.

2. Description of the Prior Art

It is well known in the art to form or size granola pieces from a slab or sheet of granola. Traditional methods of sizing granola includes the use of guillotines, knives, pin breakers, rakes, forks, enrobers, and/or plows.

One such method is disclosed in United States Patent Publication No. 2010/0028507 to Mesu et al. (the Mesu publication). The Mesu publication discloses a method for making a granola or snack food product. The method includes the steps of mixing the ingredients for the granola product with a super saturated sugar solution to form a mixture that is formable when the super saturated sugar is at an elevated temperature and sets when the saturated sugar solution is at room temperature. The method includes the step of forming the mixture into a product precursor at the elevated temperature. In one embodiment, the heated mixture of ingredients and binder are formed into a sheet and the sheet is cut into snack bars via the combination of rotating knives and/or a guillotine. In another embodiment, the hot mixed ingredients and binder are cut into cubes and these cut cubes are transferred to an enrober. The enrober comprises a rotating cylinder having ground material disposed therein. The cut cubes are subjected to the rotating action of the cylinder to convert the cut cubes into more rounded clusters.

Another such method is disclosed in U.S. Pat. No. 6,800,310 to Squire et al. (the Squire patent). The Squire patent discloses a process for preparing an agglomerated cereal product. The method claims are specific to feeding a base cereal having a crisp, friable cereal product into a coating reel and adding in sequence, binder ingredients comprising, liquid oil, dry binder mix, and liquid sugar syrup. The binder coated base cereal is formed into a layer or sheet for drying. The layer of the binder coated base cereal is broken into clusters. The claims of the Squire patent are silent with respect to how the clusters are formed, but the specification discloses that the binder coated base cereal is broken using traditional methods such as pin breakers, rakes, forks, and/or plows.

### SUMMARY OF THE INVENTION

In view of the above, the present invention provides for a rotary sizing apparatus for forming granola pieces. The rotary sizing apparatus includes a diversion portion extending along a transfer axis between a receiving end and an exit end for receiving a granola slab from a transfer device at the receiving end and moving the granola slab toward the exit end. A rotary breaking device is disposed adjacent and in spaced relationship to the exit end of the diversion portion for receiving the granola slab from the exit end of the diversion portion. The rotary breaking device is rotatable about a rotary breaking axis disposed above the transfer axis and includes at least one blade for rotatably striking a top side of the moving granola slab to break the granola slab into a plurality of granola pieces.

The present invention further provides for a method of forming granola pieces. The method begins by moving a granola slab having a top side along a transfer device, and then transferring the granola slab from the transfer device to a diversion portion which extends along a transfer axis to an exit end. The method proceeds by moving the granola slab from the exit end of the diversion portion to a rotary breaking device including at least one blade, and rotating the rotary breaking device about a rotary breaking axis disposed above the transfer axis to strike the top side of the moving granola slab and break the granola slab into a plurality of granola pieces.

### ADVANTAGES OF THE INVENTION

An advantage of the subject invention includes the improved quality of sized granola pieces or clusters. When compared to traditional granola or cluster processes, the process of the present invention yields a higher percent of product at the large sieve sizes. In other words, the subject invention improves the consistency of the product at the large sieve sizes while correspondingly reducing waste that would otherwise be created by the presence of a significant amount of smaller sieve sizes.

Another advantage of the subject invention includes more control over the sizing of the granola pieces.

Another advantage of the subject invention includes more flexibility in the line location of the rotary breaking device relative to an oven or dryer allowing for optimization of the glass transition phase of the granola slab when the granola slab is fed to the rotary breaking device.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a rotary sizing apparatus according to the subject invention;

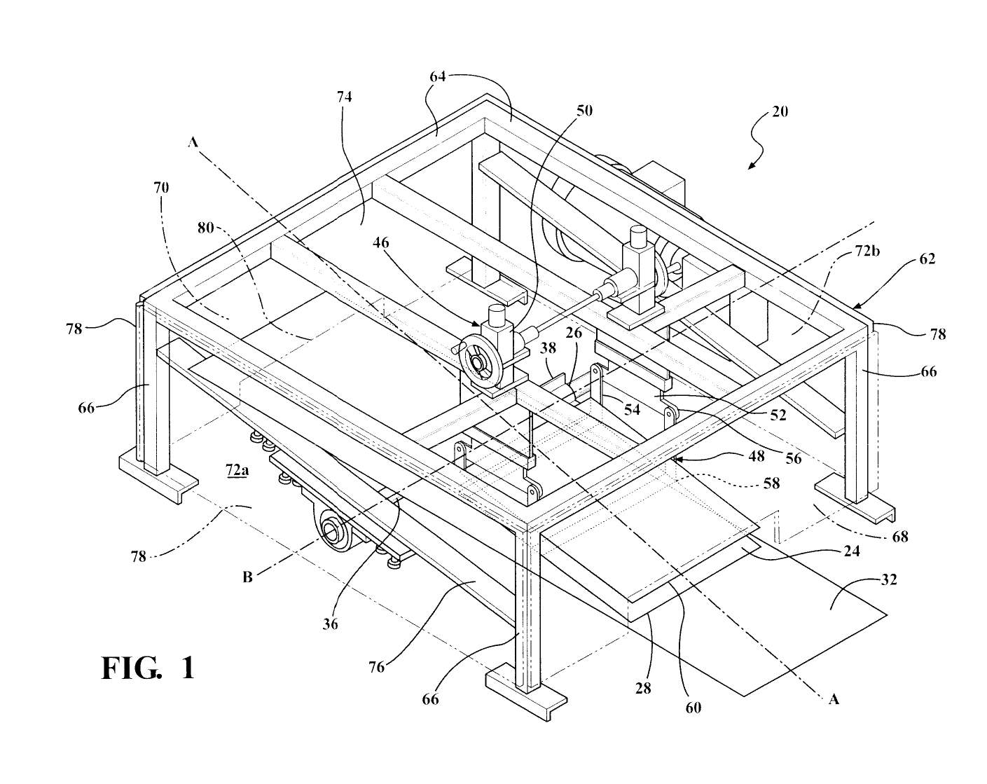

FIG. 2 is a top plane view of the rotary sizing apparatus according to the subject invention;

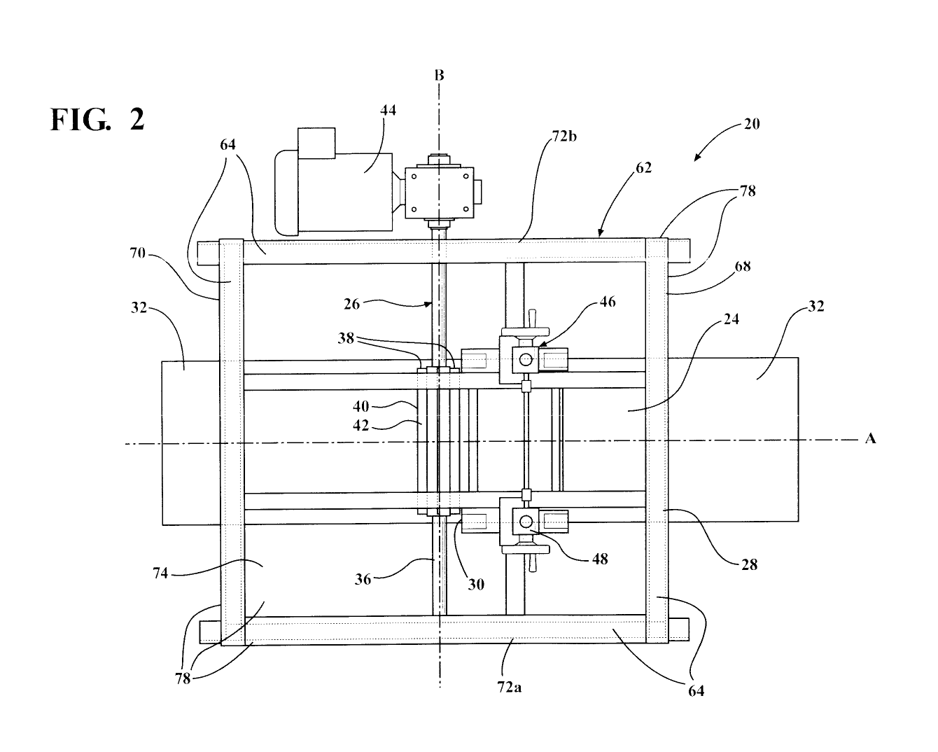

FIG. 3 is a side view of the rotary sizing apparatus according to the subject invention;

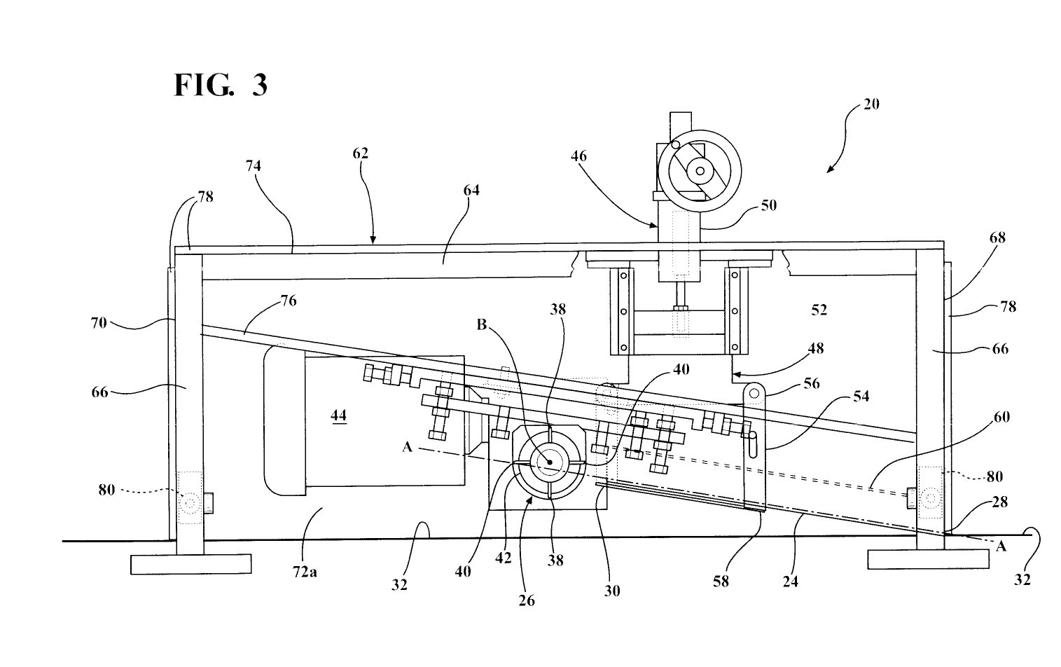

FIG. 4 is a front view of the rotary sizing apparatus according to the subject invention; and

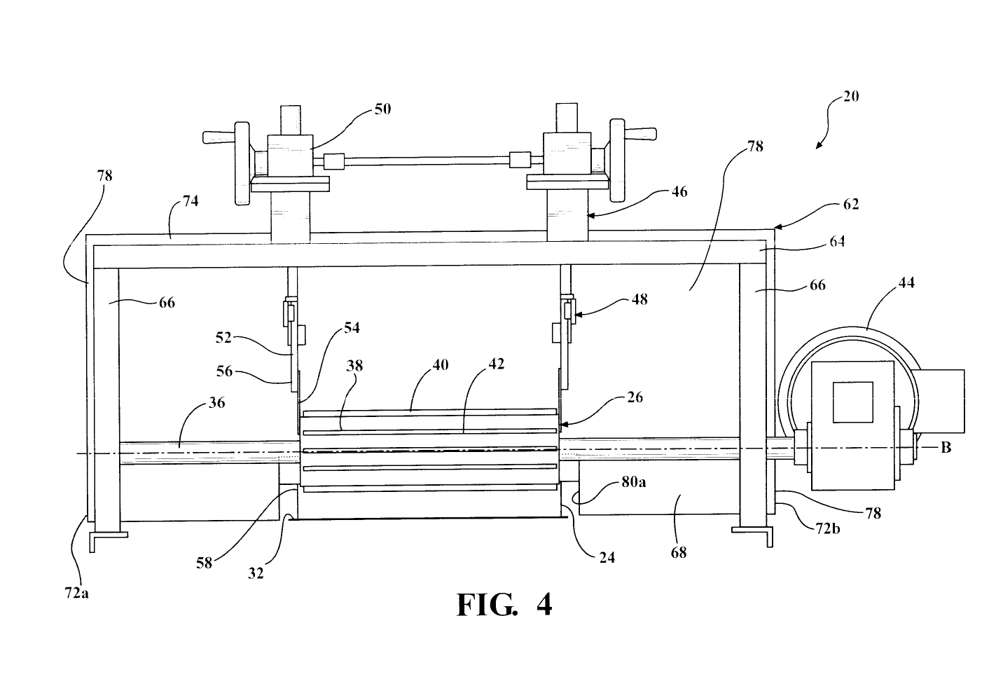

FIG. 5 is a exploded view of a portion of FIG. 1 illustrating a breaking angle of the rotary sizing apparatus.

### DETAILED DESCRIPTION OF THE ENABLING EMBODIMENTS

Referring to the Figures, wherein like numerals indicate corresponding parts throughout the several views, a rotary sizing apparatus 20 for forming granola pieces is generally shown.

The present invention relates generally to a rotary sizing apparatus 20 and process for forming granola pieces. The rotary sizing apparatus 20 is used to break a large slab or ropes of granola having a top side and a bottom side into smaller pieces for use as a cereal or snack product. The granola is formed by any method known in the art of forming granola. The rotary sizing apparatus 20 includes a diversion portion 24 and a rotary breaking device 26 is disposed upstream of the diversion portion 24. The diversion portion 24 may be a flat tray that extends between a receiving end 28 and an exit end 30 along a transfer axis A. The diversion portion 24 is movable between a feeding position and a by-pass position. In the feeding position, the receiving end 28 engages the transfer device 32 to receive the granola slab or ropes from the transfer device 32 and divert the granola slab or ropes to the rotary breaking device 26. The exit end 30 of the diversion portion 24 is disposed adjacent and in spaced relationship to the rotary breaking device 26 to feed the granola slab or ropes to the rotary breaking device 26 to break or form the granola slab or ropes into smaller pieces or clusters. The rotary breaking device 26 includes a shaft portion 36 that is rotatable about a rotary breaking axis B disposed above the transfer axis A and includes a plurality of blades 38 that are equally spaced about the shaft portion 36. The plurality of blades 38 extend outwardly from the shaft portion 36 and are rotatable with the shaft portion 36 to strike the top side of the granola slab or ropes that are fed to the rotary breaking device 26 from the exit end 30 of the diversion portion 24 to break or form the granola slab or ropes into the smaller pieces or clusters. While the exemplary embodiment shows the blade 38 as a straight or flat blade, the blade 38 can also be curved or non-linear.

The rotary sizing apparatus 20 of the present invention includes a transfer device 32 for moving the granola slab. The transfer device 32 can be any transfer device 32 known in the art including, but not limited to an oven band, a belt conveyor or a roller conveyor.

The transfer device 32 moves at a first speed to move the granola slab. The movement of the granola slab at this first speed may in addition, control the size of the granola pieces formed by the rotary sizing apparatus 20. In the present invention, the first speed and the size of the granola pieces are inverse to each other, i.e., the higher the first speed, the smaller the granola pieces will generally be. The speed at which the transfer device 32 moves may be variable and may be controlled by a user. In such instances, the transfer device 32 may include a transfer device control mechanism that controls the first speed of the transfer device 32 and thus the size of the granola pieces.

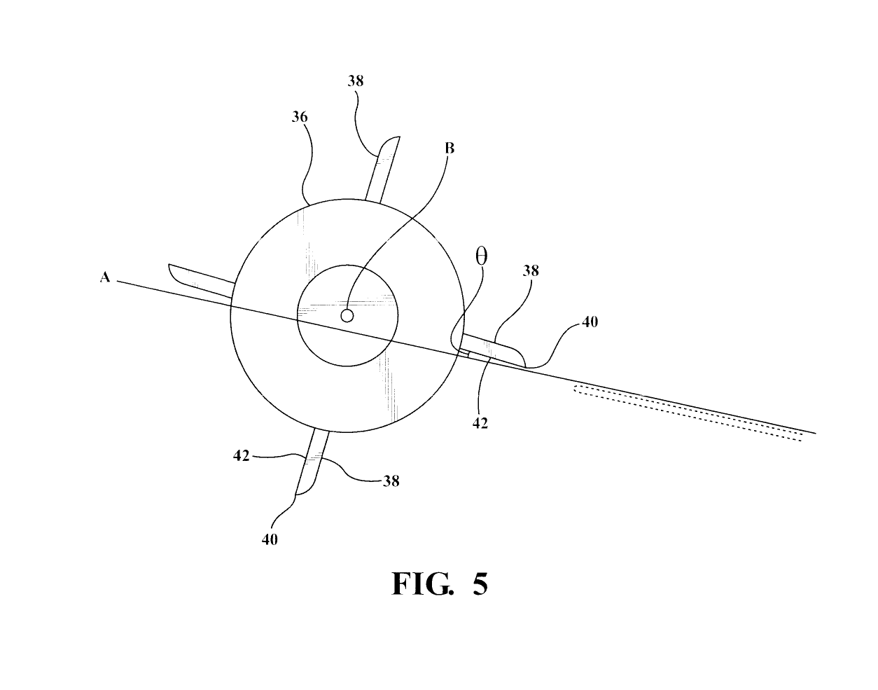

The rotary sizing apparatus 20 further includes a rotary breaking device 26. The rotary breaking device 26 may include a shaft portion 36 that is spaced from the transfer device 32 and extends along the rotary breaking axis B disposed above the transfer axis A. The rotary breaking device 26 is rotatable about the rotary breaking axis B and includes at least one blade 38 that extends radially from the shaft portion 36 to a distal end 40. While the exemplary embodiment shows the distal end 40 of the blade 36 being a straight edge, the distance between the shaft portion 36 and the distal end 40 can vary to define a non-straight edge. In the preferred embodiment, the rotary breaking device 26 includes a plurality of blades 38 that extend from the shaft portion 36 to a distal end 40. As best shown in FIG. 5, when each of the distal ends 40 of the blades 38 engage the top side of the granola slab during rotation of the rotary breaking device 26, the blades 38 establish a breaking angle θ defined relative to the top side of the granola slab and which extends from the distal end 40 of the blade 38 when the distal end 40 engages the top side of the granola slab to the rotary breaking axis A. In the preferred embodiment, each of the blades 38 extend radially from the shaft portion 36 to define a flat portion 42 of the blade that establishes the breaking angle θ. In the preferred embodiment, the breaking angle θ is between zero and forty-five degrees, and ideally between zero and fifteen degrees. If the breaking angle θ is greater than forty-five degrees, each of the blades 38 will start to pull the granola slab off the exit end 30 of the diversion portion 24 instead of breaking the granola slab into a plurality of granola pieces. In the preferred embodiment, broken granola pieces from the rotary breaking device 26 are less than or equal to 35% through an 8 mm screen. In a preferred embodiment, the broken granola pieces from the rotary breaking device 26 are more than or equal to 50% on a 20 mm screen, and more preferably 85% on a 20 mm screen. In a preferred embodiment, the broken granola pieces from the rotary breaking device 26 are more than or equal to 50% on a 20 mm screen, and the broken granola pieces which pass through the 20 mm screen are less than or equal to 35% through an 8 mm screen.

The shaft portion 36 of the rotary breaking device 26 rotates at a second speed. The rotation of the shaft portion 36 and the blades 38 extending therefrom may, in addition, control the size of the granola pieces formed by the rotary sizing apparatus 20. The second speed and the size of the granola pieces are inverse to each other, i.e., the greater the second speed, the smaller the granola pieces will generally be. The speed at which the shaft portion 36 of the rotary breaking device 26 rotates may be variable and may be controlled by a user. A motor 44 may be secured to the shaft portion 36 to rotate the shaft portion 36 at the second speed. In an alternative embodiment, the rotary breaking device 26 may include a rotary breaking device control mechanism that is in communication with the shaft portion 36 to control the second speed of the shaft portion 36 of the rotary breaking device 26 and thus the size of the granola pieces. In the preferred embodiment, the rotary breaking device 26 control mechanism is in communication with the motor 44.

The blades 38 are spaced radially about the shaft portion 36. Generally, the blades 38 are equally spaced about the shaft portion 36, but the spacing may be varied. Each of the plurality of blades 38 rotate about the rotary breaking axis B along with the rotary breaking device 26. The number of blades 38 and the radial spacing between adjacent blades 38 may further control the size of the granola pieces. The number of the blades 38 and the size of the granola pieces are inverse to each other, i.e., the greater the number of the blades 38, the smaller the granola pieces will generally be. Further, the spacing between adjacent ones of the blades 38 and the size of the granola pieces are proportional to each other, i.e., the smaller the spacing between adjacent ones of the blades 38, the smaller the granola pieces will generally be.

In an alternative embodiment, each of the plurality of blades 38 may be spaced from the shaft portion 36 of the rotary breaking device 26. In such an embodiment, the plurality of blades 38 would be secured to the shaft portion 36 via a connection mechanism and would rotate with the shaft portion 36 and about the rotary breaking axis B.

In yet another alternative embodiment, the rotary breaking device 26 may include an insert that mates with the shaft portion 36 to be rotated with the shaft portion 36. In this alternative embodiment, the insert includes an outer surface portion and the insert defines the at least one blade 38 that extends radially from the outer surface of the insert to define the flat portion 42 that strikes the granola slab to break or shear the granola slab into the plurality of granola pieces. The use of the insert allows for the number of blades 38 to be easily changed. That is, an insert having four blades 38 may be quickly changed for an insert have six blades 38 or any other number of blades 38. The insert may define a channel that extends between first and second inserts ends. The channel is disposed over the shaft portion 36 to mate the insert to the shaft portion 36 such that the insert rotates with the shaft portion 36. The shape of the channel corresponds to the shape of the shaft portion 36 so that the insert may slide over the shaft portion 36. The insert may be secured to the shaft portion 36 using any known securing mechanism known in the art.

The rotary sizing apparatus 20 further includes a diversion portion 24 that is disposed along the transfer device 32 downstream of the rotary breaking device 26. The diversion portion 24 may be any lifting mechanism known in the art, including but not limited to a second conveyor movable between a feeding position and a by-pass position and having an edge portion disposed at a receiving end 28 for diverting the granola slab from the transfer device 32 to the diversion portion 24. In the exemplary embodiment, the diversion portion 24 is a flat tray that extends between a receiving end 28 and an exit end 30 and is movable between a feeding position and a by-pass position. In the feeding position, the receiving end 28 engages the transfer device 32 to divert the granola slab from the transfer device 32 to be fed to the rotary breaking device 26. In the by-pass position, the receiving end 28 is spaced from the transfer device 32 to allow the granola slab to remain on the transfer device 32 and by-pass the rotary breaking device 26. The exit end 30 of the diversion portion 24 is disposed adjacent and in spaced relationship to the rotary breaking device 26, such that as the granola slab reaches the exit end 30 of the diversion portion 24, the rotary breaking device 26 engages the granola slab and breaks the granola slab into a plurality of irregularly shaped granola pieces. The position of the exit end 30 relative to the rotary breaking device 26 may be varied in order to control a size of the broken granola pieces. In other words, the larger the distance between the rotary breaking device 26 and the exit end 30 of the diversion portion 24, the larger the broken granola pieces will be, and vice versa. The movement of the diversion portion 24 between the feeding position and the by-pass position may include any movement known in the art. The movement of the diversion portion 24 may also include vertical movement, horizontal movement or a combination of vertical and horizontal movements.

In operation, the granola slab is moved along the transfer device 32. A granola slab exiting a dryer, or oven, and that has not completely gone through its glass transition phase is preferably fed along the transfer device 32 and the diversion portion 24 towards the rotary breaking device 26. The distance between the rotary breaking device 26 and the dryer or oven may be varied. This flexibility in the line location of the rotary breaking device 26 relative to an oven or dryer allows for optimization of the glass transition phase of the granola slab when the granola slab is fed to the rotary breaking device 26. When the diversion portion 24 is moved to the feeding position, the granola slab is diverted from the transfer device 32 and is directed to the rotary breaking device 26 which breaks the granola slab into the plurality of granola pieces. The continuous formed plane of the granola slab is fed orthogonally towards the rotary breaking axis B of the rotating blades 38 of the rotary breaking device 26. The granola pieces or clusters are sized by the shearing action of the rotating blades 38 and then conveyed towards packaging.

The rotary sizing apparatus 20 may further include a lifting mechanism 46, generally indicated, to move the diversion portion 24 between the feeding position and by-pass position. The lifting mechanism 46 may be any known lifting mechanism 46 known in the art. In the exemplary embodiment, the lifting mechanism 46 is in communication with the diversion portion 24 and includes a lifting portion 48 that mates with the diversion portion 24 and a lifting control device 50 that moves the lifting portion 48 and the mated diversion portion 24 between the feeding position and the by-pass position. The lifting portion 48 may include a base portion 52 that is in communication with the lifting control device 50 and at least one arm 54 that extends between a first arm end 56 and a second arm end 58. One of the arm ends 56, 58 may be mated to the diversion portion 24 and the other of the arm ends 56, 58 may be pivotally connected to the base portion 52 in order to move the lifting mechanism 46. The lifting control device 50 may be a manual device requiring a user to manually control the lifting control device 50 to move the diversion portion 24 between the feeding position and the by-pass position. The lifting control device 50 may be any manual device known in the art, including but not limited to a hand crank. In addition, the lifting control device 50 may be an automatic device that requires a user's input to move the diversion portion 24 between the feeding position and the by-pass position. The lifting control device 50 may be any automatic device known in the art.

The diversion portion 24 may further include a cover tray 60 that extends parallel to and is spaced above the diversion portion 24 to shield the granola slab as the granola slab moves over the diversion portion 24. The shape of the cover tray 60 generally corresponds to the shape of the diversion portion 24. In the exemplary embodiment, the cover tray 60 is in communication with the lifting mechanism 46 and moves parallel with the diversion portion 24 when the diversion portion 24 moves between the feeding position and the by-pass position.

The rotary sizing apparatus 20 may further include a frame portion 62, generally indicated. The frame portion 62 includes a frame base 64 that is generally rectangular and a plurality of base legs 66 that extend downwardly from each of the corners of the frame base 64 to define the frame portion 62. The frame portion 62 is generally box-shaped and includes an entry side 68, an exit side 70 opposite the entry side 68, a pair of lateral sides 72a, 72b opposite each other and extending between the entry and exit sides 68, 70, and a top 74 extending between the entry and exit sides 68, 70. A plurality of support legs 76 may extend between adjacent base legs 66 and along each of the lateral sides 72a, 72b to support the shaft portion 36 of the rotary breaking device 26.

The frame portion 62 may further include a plurality of shield portions 78. In the exemplary embodiment, each of the sides 68, 70, 72a, 72b and the top 74 have one of the shield portions 78 disposed there over to protect each of the granola slab and the granola pieces moving through the frame portion 62. The shield portions 78 disposed on the entry and exit sides 68, 70 may define an opening 80a, 80b that is disposed adjacent the transfer device 32. The openings 80a, 80b accommodate for the movement of the granola slab into the frame portion 62 and the movement of the granola pieces out of the frame portion 62.

The present invention further provides for a method for forming granola pieces from a granola slab using the rotary sizing apparatus 20. In summary, the granola slab is moved along the transfer device 32. The diversion portion 24 is then positioned in the feeding position by engaging the receiving end 28 of the diversion portion 24 with the transfer device 32 to divert the granola slab from the transfer device 32 and along the diversion portion 24. The granola slab is fed from the exit end 30 of the diversion portion 24 to the rotary breaking device 26. In the preferred embodiment, the granola slab is fed orthogonally towards the rotary breaking axis B of the rotary breaking device 26. The rotary breaking device 26 is rotated about the rotary breaking axis B to break the granola slab into a plurality of granola pieces.

In an alternative embodiment, the granola slab may be altered prior to being fed to the rotary breaking device 26. For example, the granola slab is grooved or scored using a grooving device to create a template of the granola pieces and thus influence the breaking of the granola slab along the grooves or scores. In the preferred embodiment, the grooves or scores extend through the top side of the granola slab, but do not pass all the way through the granola slab to the bottom side. In other words, the grooves or scores pass through most of the granola slab but do not extend all the way through. In the preferred embodiment, the granola slab is grooved or scored using the grooving device while the granola slab is still amorphous and pliable, and thus prior to the crystalline state of the granola slab. The grooving mechanism may be any known grooving mechanism known in the art such as rakes, forks, plows, dies, or the like. In one alternative embodiment, the granola slab is formed into a plurality of granola ropes. In another alternative embodiment, the granola slab is formed to have a particular shape. That is, a granola slab that typically includes a generally flat top and bottom may be altered to adjust the shape of the granola slab so that the granola slab has varying thickness over the slab. By reducing the thickness of the granola slab in certain positions, the user can influence the breaking the slab at these reduced thickness portions and further control the sizing the granola pieces by the rotary breaking device 26.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

What is claimed is:

1. A rotary sizing apparatus for forming granola pieces comprising:
a transfer device for moving a granola slab having a top side;
a diversion portion extending along a transfer axis between a receiving end and an exit end for receiving the granola slab from said transfer device at said receiving end and moving the granola slab toward said exit end;
a rotary breaking device disposed adjacent and in spaced relationship to said exit end of said diversion portion for receiving the granola slab from said exit end of said diversion portion; and
said rotary breaking device rotatable about a rotary breaking axis disposed above said transfer axis and including at least one blade for rotatably striking the top side of the moving granola slab to break the granola slab into a plurality of granola pieces.

2. A rotary sizing apparatus as set forth in claim 1 further comprising:
said at least blade extending to a distal end for engaging the top side of the granola slab during rotation of said blade to establish a breaking angle of said rotary breaking device defined relative to the top side of the granola slab and extending from said distal end of said blade to said rotary breaking axis.

3. A rotary sizing apparatus as set forth in claim 2 wherein said breaking angle is between zero and forty-five degrees.

4. A rotary sizing apparatus as set forth in claim 3 wherein said breaking angle is between zero and fifteen degrees.

5. A rotary sizing apparatus as set forth in claim 2 wherein said rotary breaking apparatus includes a shaft portion and said at least one blade extends radially from said shaft portion to said distal end to define a flat portion of said blade for establishing said breaking angle.

6. A rotary sizing apparatus as set forth in claim 1 further including:
a grooving device disposed along said transfer device for grooving the granola slab to establish a template for the broken granola pieces.

7. A rotary sizing apparatus as set forth in claim 6 wherein the granola slab extends from the top side to a bottom side disposed along said transfer device and said grooving device passes through the top side of the granola slab but does not extend through the granola slab to engage the bottom side.

8. A rotary sizing apparatus as set forth in claim 1 wherein said spaced relationship of said rotary breaking device and said exit end of said diversion portion is adjustable for controlling a size of the broken granola pieces.

9. A rotary sizing apparatus as set forth in claim 1 wherein said rotary breaking device includes a plurality of blades.

10. A rotary sizing apparatus as set forth in claim 1 wherein said transfer device moves at a first speed for moving the granola slab and said first speed is adjustable for controlling a size of the broken granola pieces.

11. A rotary sizing apparatus as set forth in claim 1 wherein said rotary breaking apparatus rotates at a second speed and said second speed is adjustable for controlling a size of the broken granola pieces.

12. A rotary apparatus as set forth in claim 1 wherein said receiving end of said diversion portion is movable between a feeding portion wherein said receiving end engages said transfer device for receiving the granola slab and a by-pass position wherein said receiving end is disposed in spaced relationship to said transfer device for allowing the granola slab to remain on said transfer device and by-pass said rotary breaking device.

13. A rotary apparatus as set forth in claim 12 further including:
a lifting mechanism in communication with said diversion portion and including a lifting portion for mating with said diversion portion;
a lifting control device for moving said lifting portion and said mated diversion portions between said feeding position and said by-pass position; and
said lifting portion including a base portion in communication with said lifting control device and at least one arm extending between a first arm end and a second arm end, one of said arm ends being mated with said diversion portion and the other of said arms being pivotally connected to said base portion.

14. A method for forming granola pieces comprising:
moving a granola slab having a top side along a transfer device;
transferring the granola slab from the transfer device to a diversion portion extending along a transfer axis to an exit end;
moving the granola slab from the exit end of the diversion portion to a rotary breaking device including at least one blade; and
rotating the rotary breaking device about a rotary breaking axis disposed above the transfer axis to strike the top side of the moving granola slab with the blade and break the granola slab into a plurality of granola pieces.

15. A method as set forth in claim 14 further comprising:
striking the moving granola slab with the blade of the rotary breaking device disposed at a breaking angle relative to the top side of the granola slab.

16. A method as set forth in claim 15 wherein the breaking angle is between zero and forty-five degrees.

17. A method as set forth in claim 16 wherein the breaking angle is between zero and fifteen degrees.

18. A method as set forth in claim 14 further comprising:
grooving the granola slab with a grooving device prior to said transferring of the granola slab from the transfer device to the diversion portion to establish a template for the broken granola pieces.

19. A method as set forth in claim 18 wherein the granola slab extends from the top side to a bottom side and said grooving the granola slab further includes passing the grooving device through the top side of the granola slab but not through the granola slab to the bottom side.

20. A method as set forth in claim 14 further comprising:
adjusting a spaced relationship of the rotary breaking device relative to the exit end of the diversion portion to control a size of the broken granola pieces.

21. The method as set forth in claim 14 further comprising:
moving the transfer device at a first speed to move the granola slab; and
controlling the first speed to control a size of the broken granola pieces.

22. The method as set forth in claim 14 further comprising:
rotating the rotary breaking device at a second speed; and
controlling the second speed to control a size of the broken granola pieces.

23. A method for forming irregularly shaped granola pieces comprising the steps of:
moving a granola slab having a top side along a transfer device;
transferring the granola slab from the transfer device to a diversion portion extending along a transfer axis to an exit end;
moving the granola slab from the exit end of the diversion portion to a rotary breaking device including at least one blade;
rotating the rotary breaking device about a rotary breaking axis disposed above the transfer axis to strike the top side of the moving granola slab and break the granola slab into a plurality of granola pieces; and
wherein the broken granola pieces from the rotary breaking device are less than or equal to 35% through an 8 mm screen.

24. A method as set forth in claim 23 further comprising:
striking the moving granola slab with the blade of the rotary breaking device disposed at a breaking angle relative to the top side of the granola slab.

25. A method as set forth in claim 24 wherein the breaking angle is between zero and forty-five degrees.

26. A method as set forth in claim 24 wherein the breaking angle is between zero and fifteen degrees.
